(19) United States
(12) Patent Application Publication
(10) Pub. No.: US 2010/0030650 A1
(43) Pub. Date: Feb. 4, 2010

(54) CONTROL UNIT AND METHOD FOR DELIVERING MESSAGES

(75) Inventors: Janne Aaltonen, Turku (FI); Ismo Antikainen, Masala (FI); Petteri Koponen, Espoo (FI)

Correspondence Address: BARNES & THORNBURG LLP, 750-17TH STREET NW, SUITE 900, WASHINGTON, DC, 20006-4675, US

(73) Assignee: CVON INNOVATIONS LTD, London (GB)

(21) Appl. No.: 12/446,698

(22) PCT Filed: Oct. 27, 2006
(86) PCT No.: PCT/FI06/50467

§ 371 Date: Apr. 22, 2009

(51) Int. Cl. G06Q 30/00; G06F 15/16; G06Q 50/00; G06Q 10/00

(52) U.S. Cl. 705/14.69; 709/206; 705/34; 705/400

(57) ABSTRACT

The invention relates to a control unit for message delivery in a communications network, the control unit including a mechanism for receiving information relating to predetermined metering data associated with successful message delivery, a mechanism for conveying the information relating to predetermined metering data associated with successful message delivery to a metering data analyzing system of the communications network, and a mechanism for receiving message delivery information from the communications network.

### FIELD

The invention relates to a control unit and a method for delivering messages in a communications network.

### BACKGROUND

Mobile marketing and advertising are considered as a channel to reach consumers by utilizing assets and characteristics of mobile media, namely individuality and attainability.

Today's mobile marketing is mostly based on push campaigns or pull campaigns that acquire consumers' mobile phone numbers.

An example of a push campaign is a short message service (SMS) campaign where an advertisement is sent to a group of consumers using SMS.

An example of a pull campaign is a “text-to-win” campaign, wherein an article contains a code which a consumer may send to a telephone number used for the campaign and, as a return, he or she receives a notification of a possible price. Furthermore, the consumer receives marketing messages.

However, today's mobile marketing and advertising systems are still quite undeveloped. Several deficiencies exit: for example, real-time invoices to advertisers are impossible to obtain or this is difficult and/or expensive to implement.

### BRIEF DESCRIPTION OF THE INVENTION

According to an aspect of the invention, there is provided a method for delivering messages in a communications network, the method comprising receiving information relating to predetermined metering data associated with successful message delivery; conveying the information relating to predetermined metering data associated with successful message delivery to a metering data analyzing system of the communications network; and receiving message delivery information from the communications network.

According to another aspect of the invention, there is provided a control unit for message delivery in a communications network, the control unit comprising: means for receiving information relating to predetermined metering data associated with successful message delivery; means for conveying the information relating to predetermined metering data associated with successful message delivery to a metering data analyzing system of the communications network; and means for receiving message delivery information from the communications network.

The invention provides several advantages.

An embodiment of the invention provides a possibility to obtain real-time invoices utilizing billing systems of a communications network. This approach produces invoicing and/or delivery information in the network where the events to be charged are generated, thus making invoicing less complicated and expensive than in prior art systems.

### LIST OF DRAWINGS

In the following, the invention will be described in greater detail with reference to the embodiments and the accompanying drawings, in which

FIG. 1 shows an example of a communications network;

FIG. 2 illustrates an example of an arrangement according to an embodiment of the invention;

FIG. 3 illustrates an example of a control unit; and

FIG. 4 is a flow chart.

### DESCRIPTION OF EMBODIMENTS

Message delivery according to embodiments of the invention is typically carried out in a communications network. Some examples of the communications networks are a Universal Mobile Telecommunications System (UMTS) radio access network (UTRAN), Global System for Mobile Communications (GSM) and its modifications, Wireless Local Area Network (WLAN), Worldwide Interoperability for Microwave Access (WiMAX), Bluetooth®, Personal Communications Services (PCS) and systems using ultra-wideband (UWB) technology.

A variety of message types can be used in embodiments of the invention: the messages may be Short Message Service (SMS) messages, multimedia messages (such as Multimedia Messaging Services (MMS) messages), Wireless Application Protocol (WAP) messages, WAP-push messages, messages in a broadcasting format (examples of such formats are Digital Video Broadcasting for Handheld devices (DVB-H), Integrated Services Digital Broadcasting (ISDB), Digital Audio Broadcasting (DAB)) and messages conveyed via the Internet, etc.

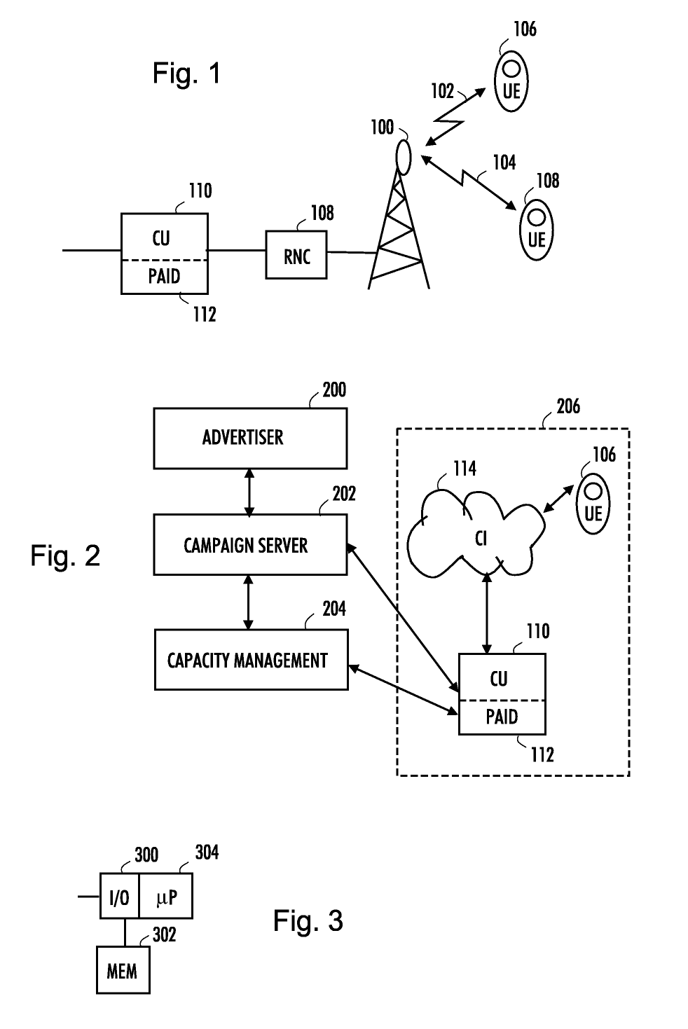

FIG. 1 is a simplified illustration of a system to which embodiments according to the invention are applicable. The system of FIG. 1 is presented as a clarifying example. It is obvious to a person skilled in the art that the embodiments of the invention may be applied to different kinds of systems.

FIG. 1 shows a part of a WCDMA (Wide Band Code Division Multiple Access) communications network. The WCDMA network is taken herein as an example of a communications network providing mobility.

The WCDMA communications network is a cellular radio system which comprises a base station 100, which has bi-directional radio links 102, 104 to user devices 106, 108. A user device may be a mobile phone, a laptop or a multimedia device, for instance.

The base station is connected to a radio network controller (or node B) 108 which in turn has a connection to a core network 110. The core network of the example includes a postpaid/prepaid billing system 112. Post-paid/prepaid systems are known in the prior art and they are not explained herein.

In this example, the base station and the radio network controller form cellular infrastructure of FIG. 2.

In the following, an example of a system for delivering messages, such as advertisements and other chargeable messages, is explained in further detail by the means of FIG. 2. An advertising campaign is used as an example, but embodiments of the example are not restricted thereto, but the invention may be used to deliver several kinds of information messages, such as invitations to a party, an appointment or a meeting.

It is obvious to a person skilled in the art that campaign messages may be delivered to several communications systems, not only one. One communications system is depicted in FIG. 2 only for the sake of clarity.

In the example of FIG. 2, an advertiser 200 orders a marketing campaign, where advertisements are delivered to consumers' user devices, such as mobile phones or multimedia devices. An advertiser may be a person, a group of persons, a company, a civil service department, etc.

Campaign material (including texts, images, sounds videos, hypertext markup language (html), tags, links, etc.) is typically designed by an advertising agency. The advertising campaign material may be a multimedia message, a video, a text message, etc. The advertiser typically defines a target group for the campaign.

A delivery plan (target consumers, delivery time, location, etc.) is made on the basis of information on occupiers of subscriber connections, which is typically collected when connection means, such as Subscriber Identity Module (SIM) cards, are handed out to the occupiers. The information may include age, sex, residence, hobbies, taste in music, occupation, etc. The information is collected with approvals of the occupiers, typically by using a questionnaire. The information may be combined to form consumer profiles.

The use of consumer profiles while making delivery plans provides means for aiming campaigns more precisely at consumers presumed to be interested in commodities in question.

Campaign material may be delivered to all occupiers of subscriber connections or to some percentage thereof. This kind of advertising can be supposed to be less effective than a campaign focused on a more precisely determined group of consumers.

Let us take one example of consumer profiling. A campaign may be targeted at persons of a particular sex, living in a certain area and belonging to a certain age group. A campaign may advertise concerts. Statistically, women and men like different sort of music, middle-aged people like different kind of music than teenagers, etc. The most effective campaign would not be to advertise the same concert to all occupiers of subscriber connections. Instead, consumer profiling may give a possibility to advertise different concerts to different kinds of people.

Further, the campaign service provider may use selective pricing policy for campaigns not using profiles and for campaigns using profiles; the more precise the definition of the target group, the more expensive a campaign message. For instance, a concert advertisement targeted at girls belonging to the age group of 16 to 19 and living in the London area may be more expensive per a message than a concert advertisement campaign to all occupiers of a subscriber connection in the London area.

The information on occupiers of subscriber connections may be stored in a campaign server 202. The campaign server may further include billing information, i.e. agreed expenses of a campaign or the amount of money paid for the campaign. The pricing policy may also be stored in the campaign server. The campaign server may deliver advertisement campaign material directly to a cellular infrastructure 114 to be sent to user devices according to the delivery plan, or it conveys the material and the delivery plan to a capacity management unit 204 which then communicates with a communications network 206. In both cases, the campaign server conveys the billing information to the capacity management unit.

The exemplary communications network includes a cellular infrastructure 114, one or more user terminals 106, and a core network 110 which includes a pre-paid/post-paid billing system 112.

The capacity management unit typically conveys information on credit (billing information), i.e. agreed campaign expenses or the amount of money prepaid to a billing system of the communications network, which in this example is the pre-paid/post-paid system. The billing information and/or pricing policy may be stored in the capacity management unit.

The capacity management unit typically gives the campaign server a permission to start the campaign, if the campaign itself is carried out by the campaign server. The permission may be given after the billing system has reported that it has arranged the billing.

If the campaign is carried out by delivering short message service (SMS) messages, the campaign server or capacity management unit sends messages to a short message center (SMSC), which is a part of the core network (not shown), for delivery to user devices. The user devices confirm the receipt of messages to the SMSC and the SMSC informs the billing system on message delivery, typically the number of successfully delivered messages.

The SMSC also informs the capacity management unit about the number of successfully delivered messages. This can be carried out in real-time, in selected time intervals or after the campaign is partially or completely over. The capacity management unit conveys the information to the campaign server from which information on the campaign can be sent to an advertiser providing the advertiser an option to get information on successfully delivered campaign messages, that is to say, on the real coverage of the campaign on an event basis.

If pre-paid billing is used, the capacity management unit loads the prepaid sum to a pre-paid system of the communications network. If, on the other hand, post-paid billing is used, an invoice is sent to the advertiser on the basis of the information obtained from the campaign server and/or the capacity management unit.

The billing system is typically the same one as that used by the operator of the communications network for its own billing. The billing may also be carried out in a way used by the operator in its billing, for instance subtracting money spent from a pre-paid account.

A campaign server and a capacity management unit may be integrated to be parts of a same unit or they may be separate devices.

An embodiment of the invention typically uses a billing system (prepaid/post-paid) of a communications network. This approach makes it possible to control the usage of advertisement “time” and collect delivery reports without separate systems integrated into the communications network. Also charging by events (messages received by user devices) is possible.

In FIG. 3, an example of a control unit for carrying out the message delivery described above is depicted.

The control unit is typically a server which may include input/output interfaces 300 to receive and transmit information. The server typically also includes or is connected to a memory 302. The core of the server is usually a microprocessor 304. The control unit according to an embodiment of the invention carries out for instance the conveyance of campaign expenses or the amount of money prepaid to a billing system of the communications network.

Naturally, the control unit may differ from what is depicted in FIG. 3.

Hence, a control unit of the example may include means for receiving information relating to predetermined metering data associated with successful message delivery, means for conveying the information relating to predetermined metering data associated with successful message delivery to a metering data analyzing system of a communications network, and means for receiving message delivery information from the communications network.

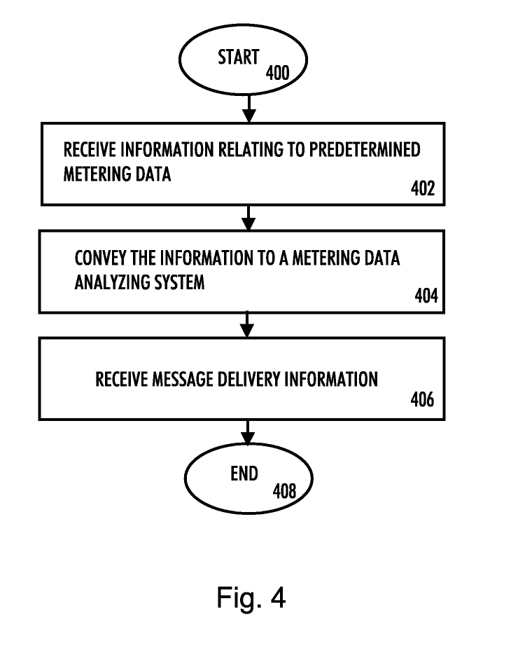

FIG. 4 is a flow chart depicting an embodiment of a method for delivering messages in a communications network.

The embodiment starts in block 400.

In block 402, information relating to predetermined metering data associated with successful message delivery is received. The information relating to metering data may be information on credit (billing information), i.e. agreed campaign expenses or the amount of money prepaid to a billing system of the communications network.

In block 404, the information relating to predetermined metering data associated with successful message delivery is conveyed to a metering data analyzing system of the communications network. The metering data analyzing system is typically the billing system used by an operator of the communications network for its own billing. The billing may also be carried out in a way used by the operator for its billing, for instance subtracting money spent from a pre-paid account. Thus, no need exists for a separate billing system for the message delivery described above.

In block 406, message delivery information is received from the communications network. Typically, the communications network informs on the number of successfully delivered messages. This can be carried out in real-time, in selected time intervals, or after the campaign is partly or completely over.

In one embodiment, message delivery information may be conveyed to an element producing message delivery reports. The delivery reports may include information on successfully delivered advertising campaign messages that is to say, on the real coverage of the campaign. Campaign reports inform the orderer of the campaign on how the campaign proceeded.

The method may further include receiving information on a message to be delivered in a communications network, such as advertising campaign material, and conveying to the communications network the information on the message to be delivered, such as sending to the communications network the advertising campaign material. The method may also include generating message delivery reports.

If messages to be delivered are advertisements, advertisement campaign material (material including texts, images, sounds, etc.) is typically designed by an advertising agency. The advertising campaign material may be a multimedia message, a video, a text message, etc. The advertiser typically defines a target group for the campaign.

A delivery plan (target consumers, delivery time, location, etc.) is made on the basis of information on occupiers of subscriber connections, which is typically collected when the connection means are handed out to the occupiers. The information may include age, sex, residence, hobbies, taste in music, occupation, etc. The information is collected with approvals of the occupiers, typically by using a questionnaire. The information may be combined to form consumer profiles.

The embodiment ends in block 408. The embodiment is repeatable in many ways, for instance for each message delivery campaign.

Embodiments of the invention may be implemented as a computer program comprising instructions for executing a computer process for delivering messages in a communications network.

The computer program may be stored on a computer program distribution medium readable by a computer or a processor. The computer program medium may be, for example but not limited to, an electric, magnetic, optical, infrared or semiconductor system, device or transmission medium. The computer program medium may include at least one of the following media: a computer readable medium, a program storage medium, a record medium, a computer readable memory, a random access memory, an erasable programmable read-only memory, a computer readable software distribution package, a computer readable signal, a computer readable telecommunications signal, computer readable printed matter, and a computer readable compressed software package.

Even though the invention has been described above with reference to an example according to the accompanying drawings, it is clear that the invention is not restricted thereto but it can be modified in several ways within the scope of the appended claims.

1. A method for delivering messages in a communications network, the method comprising:
receiving information relating to predetermined metering data associated with successful message delivery;
conveying the information relating to predetermined metering data associated with successful message delivery to a metering data analyzing system of the communications network; and
receiving message delivery information from the communications network.

2. The method of claim 1, wherein the information relating to predetermined metering data comprises information on agreed expenses of a message delivery or amount of money paid for the message delivery.

3. The method of claim 1, wherein the metering data analyzing system is a billing system used by an operator of the communications network.

4. The method of claim 1, wherein the message delivery information comprises information on a number of successfully delivered messages.

5. The method of claim 1, wherein the message delivery information is produced in real-time, in selected time intervals, or after message delivery campaign is at least partly over.

6. The method of claim 1, further comprising conveying the message delivery information to an element producing message delivery reports.

7. The method of claim 6, wherein the message delivery reports comprise information on successfully delivered advertising campaign messages.

8. The method of claim 1, further comprising collecting information on occupiers of subscriber connections for making message delivery plans.

9. The method of claim 8, further comprising applying selective pricing policy per each delivered message, the pricing policy being based on the usage of consumer profiles provided by using collected subscriber connection occupier information.

10. The method of claim 1, characterized by further comprising:
receiving information on a message to be delivered in the communications network;
conveying to the communications network the information on the message to be delivered; and
generating message delivery reports.

11. A control unit for message delivery in a communications network, the control unit comprising:
means for receiving information relating to predetermined metering data associated with successful message delivery;
means for conveying the information relating to predetermined metering data associated with successful message delivery to a metering data analyzing system of the communications network; and
means for receiving message delivery information from the communications network.

12. The control unit of claim 11, wherein the information relating to predetermined metering data comprises information on agreed expenses of message delivery or amount of money paid for the message delivery.

13. The control unit of claim 11, wherein the metering data analyzing system is a billing system an used by operator of the communications network for billing.

14. The control unit of claim 11, wherein the message delivery information comprises information on number of successfully delivered messages.

15. The control unit of claim 11, further comprising means for producing message delivery information in real-time, in selected time intervals or after a message delivery campaign is at least partly over.

16. The control unit of claim 11, further comprising means for conveying the message delivery information to an element producing message delivery reports.

17. The control unit of claim 16, wherein the message delivery reports comprises information on successfully delivered advertising campaign messages.

18. The control unit of claim 11, further comprising means for collecting information on occupiers of subscriber connections for making message delivery plans.

19. The control unit of claim 18, further comprising means for applying selective pricing policy per each delivered message, the pricing policy being based on the usage of consumer profiles provided using collected subscriber connection occupier information.

20. The control unit of claim 11, further:
means for receiving information on a message to be delivered in the communications network;
means for conveying to the communications network the information on the message to be delivered; and
means for generating message delivery reports.
